(19) United States
(12) Patent Application Publication
(10) Pub. No.: US 2012/0249761 A1
(43) Pub. Date: Oct. 4, 2012

(54) Motion Picture Personalization by Face and Voice Image Replacement

(76) Inventor: Joonbum Byun, Gaithersburg, MD (US)

(21) Appl. No.: 13/078,955

(22) Filed: Apr. 2, 2011

(51) Int. Cl. H04N 7/18

(52) U.S. Cl. 348/61; 348/E07.085

(57) ABSTRACT

Disclosed invention enables ordinary person who are not non-professional movie star or singer to take a role in motion picture video. It replaces facial and voice image in existing video with someone else's facial and voice. The words, emotion, expression and feelings shown in original video are fused into that of non-professionals so that the normal person is playing a role in a movie just like the actual movie star or singer does.

### BACKGROUND OF THE INVENTION

There is no doubt that everybody want to be a movie star or famous singer. In reality, not all the wishes do not come true. However, thanks to advancement in computer graphics technology, the wish can be realized at least in motion picture. In a historic hit movie such as “Gone with the Wind” or “Star Wars”, wouldn't it be great if you were a main character? Or each of your family members could take an appropriate role in such a movie.

Current invention enables the dream come true at least in motion picture.

### BRIEF SUMMARY OF THE INVENTION

The disclosed art enables the customization of existing movie, drama, documentary film or concert video by replacing main character or player's face and voice image with your face and voice. From now on, for the shake of argument, we will call a person “client” who wishes his or her face and voice image be embedded in a motion picture.

Client's face and voice image must be first captured. If an existing movie is in traditional film, it is digitally scanned into computer video and audio image. A computer software, an embodiment of current invention, examine the video frame by frame to recognize each character's face from the video image and arrange them in such as way that it can be easily replaced with client's face image. Once it is done, only the face image in the video is replaced with client's face image frame by frame. The software captures actor's subtle facial expression and uses it to render client's facial image that corresponds to actor's facial expression.

The voice also goes through similar process. Words, language, accent in actor's or singer's voice remain unchanged. But only the characteristic of the voice is altered to that of client's so that it sounds like client is talking in the video.

### FIELD OF INVENTION

Current invention is related with motion picture, computer graphic and personalized entertainment.

### DESCRIPTION OF RELATED ART

### Detailed Description of Invention

### Brief Description of Drawing

FIG. 1 shows overall flow of motion picture images from original movie to personalized one. If original video is in film format, it is converted into digital format by digital scanner and stored in digital computer. If original motion picture is in digital format, it is used as is. Client's face and voice image are captured. Face image includes as many expression as possible such as when client is happy, angry, sad, laughing, talking, sleeping.

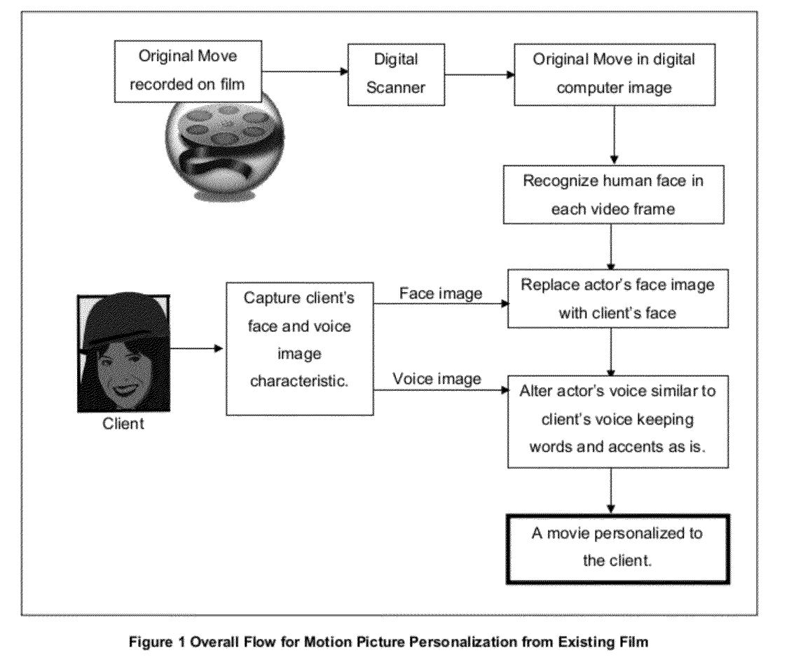

FIG. 2 shows another embodiment of current invention, which inspects each frame by frame to recognize human face image and organize them into a data structure such that they can be later easily replaced by client's face image. It also alters actor's voice in the video similar to client's one while leaving the words, accent and language without change.

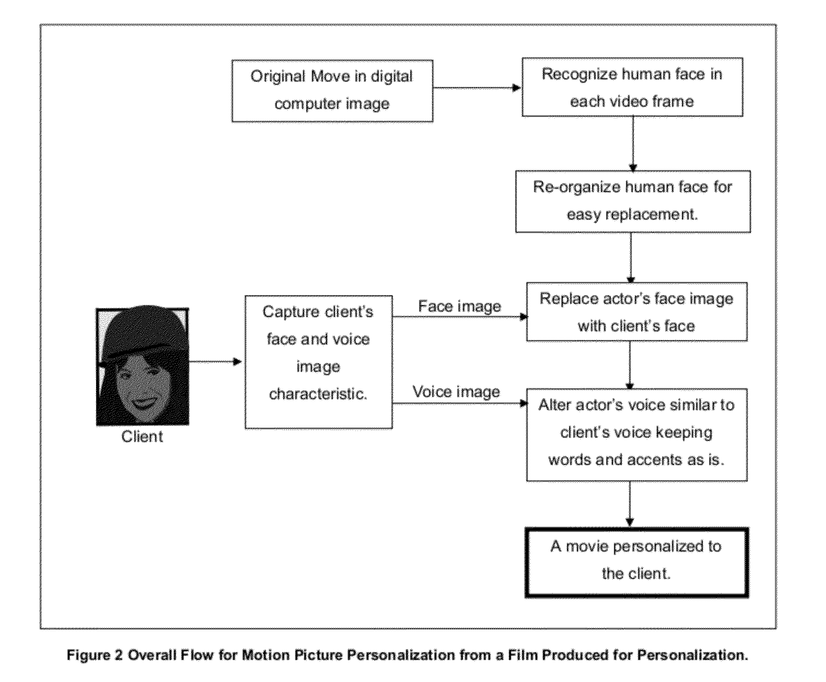

The software replaces the actor's face image with client's image frame by frame. It senses actor's expression from the facial image and transplant them into client's face image frame by frame. Running through whole video from start to beginning, it completes a movie personalized to a specific client.

What is claimed are:

1. An algorithm that replace person A's face and voice image in a video or motion picture with person B's face and voice image while having the person A's facial expression, emotion and speaking expression transplanted to person B's facial image and talking that;
converts still image of person B's face into person B's live face with person A's facial expression and emotion.
transforms person A's voice in motion picture into person B's voice by applying person B's voice characteristics into person A's voice.
